(19) United States
(12) Patent Application Publication
(10) Pub. No.: US 2010/0019883 A1
(43) Pub. Date: Jan. 28, 2010

(54) Methods of identifying RFID tag for preventing RFID tag collision, RFID reader and RFID tag using the same

(75) Inventors: Jun-Bong Eom, Jinhae-City (JP); Tae-Jin Lee, Suwon-city (KR)

Correspondence Address: HARNESS, DICKEY & PIERCE, P.L.C., P.O. BOX 8910, RESTON, VA, 20195, US

(73) Assignee: SUNGKYUNKWAN UNIVERSITY Foundation for Corporate Collaboration

(21) Appl. No.: 12/292,460

(22) Filed: Nov. 19, 2008

(30) Foreign Application Priority Data
Jul. 25, 2008 (KR) 10-2008-0073040

(51) Int. Cl. H04Q 5/22

(52) U.S. Cl. 340/10.1

(57) ABSTRACT

A method of identifying a plurality of RFID tags in an RFID reader includes generating a Query command to transmit the Query command to an RFID tag in a ready state, receiving an error detection code from the RFID tag that received the Query command, generating an acknowledgement (ACK) command to transmit the acknowledgement (ACK) command to the RFID tag that transmitted the error detection code when the error detection code is received without a collision, and receiving tag information including a protocol control (PC) and an electronic product code (EPC) of the RFID tag that transmitted the error detection code. It is possible to improve tag identification speed using an error detection code, such as a cyclic redundancy check (CRC)-16 code, which has uniformly-random characteristics like random number with 16 bits (RN 16), instead of RN 16 used in a conventional EPCglobal Class1 Generation2 standard.

### CROSS-REFERENCE TO RELATED APPLICATION

This application claims priority to and the benefit of Korean Patent Application No. 2008-0073040, filed Jul. 25, 2008, the disclosure of which is incorporated herein by reference in its entirety.

### BACKGROUND

1. Technical Field

The embodiments described herein relate to radio frequency identification (RFID), and more particularly, to methods of identifying an RFID tag for preventing RFID tag collision, and an RFID reader and tag using the methods.

2. Discussion of Related Art

RFID, one type of automatic identification like barcodes, magnetic sensors and integrated chip (IC)-cards, is technology for wirelessly recognizing data stored in a microchip of a tag using an ultra-short wave or long wave.

RFID systems receive information stored in a tag through an antenna such that a reader can obtain unique information of an object by identifying and analyzing the received information. RFID systems use a frequency, and thus are not affected by surroundings, such as snow, rain, wind, dust and magnetic flux. In addition, RFID systems can identify a tag in movement due to a fast identification speed.

Since RFID can transmit a large amount of data at high speed using a wireless channel, it is considered as substitute technology for the barcode that is currently used in industrial fields requiring product identification, such as distribution and circulation and financial services. RFID is frequently used in automatic identification systems, and has attracted attention due to its ubiquitous applicability.

However, RFID has problems regarding reliability of identified data, standardization of the technology, improvement of read rate and identification speed, and so on. Currently, RFID systems must solve the problem of low identification efficiency due to collisions between tags. Therefore, research into anti-collision protocols is required to improve a read rate and identification speed.

According to the basic process of identifying a tag in an RFID system, when a reader makes a query to a tag, the tag receiving a query signal transmits its ID to the reader. When there is one tag within the reading range of the reader, it is very easy to identify the tag. However, when there are several tags within the reading range, all the tags simultaneously transmit their information to the reader, thus causing tag collision.

Tag collision refers to when a plurality of tags simultaneously reply to an inquiry of one reader, preventing the reader from identifying any tag. When the tags which are currently used or will be used in the large-scale distribution and circulation are low-cost passive tags, available anti-collision protocols must meet many restrictions such as complexity of calculation, absence of battery, and cost increase according to a memory size. Thus, a protocol for efficiently preventing RFID tag collision is required to identify a plurality of tags in real time.

Representative anti-collision algorithms are a binary tree-based algorithm utilizing a binary characteristic that data of a tag is composed of “0”s and “1”s, and an ALOHA-based algorithm transmitting data at a desired time along a time axis.

In an RFID system using the binary tree-based anti-collision algorithm, a reader reads information of a tag bit by bit to search for the information of the tag as if it were searching a tree. The binary tree-based anti-collision algorithm has the advantage of guaranteed data transmission. Since the reader uses all data transmitted by tags, data is not lost due to tag collision. In addition, even if there are a large or small number of tags, performance according to the number of tags can be estimated using a linear equation. On the other hand, the reader must transmit as many command queries as pieces of data transmitted to the tags. Furthermore, the tags charge and discharge electricity to transmit data to the reader too many times.

According to the ALOHA-based anti-collision algorithm, it is difficult for tags to check a state of a medium. Thus, in an RFID system using the ALOHA-based anti-collision algorithm, time is divided into slots or frames, data is transmitted at a synchronized time, and all tags compete to transmit data to a reader. The ALOHA-based anti-collision algorithm guarantees high-speed data transmission by continuously transmitting data.

Framed-slotted ALOHA (FSA), an ALOHA-based anti-collision algorithm, is the most frequently used anti-collision algorithm. According to the FSA algorithm, a frame is divided into several timeslots, and each tag randomly selects one timeslot for transmission of each tag's ID. When a tag transmits its information in a timeslot, a reader can successfully read the tag. However, when collision occurs between one or more tags in a timeslot, the reader cannot identify tag information, and unread tags must retransmit their information in the next frame. This is inefficient due to waste of collision timeslots. When there are many idle timeslots in a frame, it is also inefficient. In addition, the ALOHA-based anti-collision algorithm such as the FSA algorithm must use a random number generator (RNG) to determine a point in time where a tag transmits data to a reader.

Another disadvantage of the FSA algorithm can be seen when the number of tags cannot be estimated. The FSA algorithm is easily implemented, but wastes slots when there are a small number of tags. As the number of tags increases, the tags compete for data transmission, and collision occurs between the tags. Thus, the number of slots required for identification increases tremendously, and the number of slots required for reading all the tags increases exponentially. In the extreme, even information of only one tag may not be obtained for an infinite time. Thus, the FSA algorithm shows low throughput.

Consequently, it is necessary to change a next frame size appropriately for high efficiency after estimating the number of tags in the reading range, as in dynamic FSA (DFSA).

Electronic product code (EPC) global Class1 Generation2 is a representative international standard using DFSA.

Unlike general DFSA having fixed timeslots for success, idle and collision, DFSA of EPCglobal Class1 Generation2 employs other timeslots. In order to reduce time waste caused by collision, a relatively short random number with 16 bits (RN16) is transmitted prior to EPC from a tag to a reader. Depending on whether or not reading of the transmitted RN16 is successful, the reader reads the EPC of the tag.

FIG. 1 is a timing diagram illustrating a conventional method of identifying a tag using a DFSA algorithm employing RN16 according to an EPCglobal Class1 Generation2 standard. FIG. 2 is a conceptual diagram illustrating operation of a reader and a tag according to the conventional EPCglobal Class1 Generation2 standard. The method of identifying a tag using a DFSA algorithm illustrated in FIGS. 1 and 2 is disclosed in EPCglobal Class1 Generation2 specifications version 1.0.9 regarding an RFID air interface, and will not be described here.

Referring to FIG. 1, when long protocol control (PC), EPC, and cyclic redundancy check (CRC)-16 are transmitted without transmitting a short RN16 in advance, a tag collision wastes time and reduces tag identification speed because another PC, EPC and CRC-16 need to be transmitted. Thus, according to the conventional EPCglobal Class1 Generation2 standard, RN16 is used when a tag transmits information to a reader.

Each tag randomly selects a timeslot and transmits a 16-bit RN16 50 in the timeslot. When a reader does not detect any signal, the reader tries to read tags in the next timeslot after waiting for a few timeslots.

When the reader successfully identifies the transmitted RN16 50, the reader attempts to read the tag by sending an acknowledgement (ACK) command 12 to the tag. However, when the RN16 50 is not correctly identified, or there is no reply to the ACK command 12, the reader determines that a collision has occurred.

The reader generates a Select command 10 to select a particular timeslot in which the reader identifies one tag. To identify the tag, the reader transmits Query, ACK, NAK, etc., commands to tags in Inventory round. In Access state, the reader reads or writes data from or to individual tags after the tags are uniquely identified.

The tag that received the Select command 10 prepares for operation and stays in Ready state until the tag receives a Query command. The tag that received the Query command generates a slot counter value (0 to 2^{Q}−1), i.e., RN16. When the slot counter value of the tag is reduced to 0, the tag switches to Reply state and transmits an RN16 code to the reader. When the reader does not detect a collision of RN16, the reader issues an ACK command including the RN16 of the tag. After receiving the ACK command, the tag switches to Acknowledged state. When the received ACK command is valid, the tag transmits tag information 60 including its PC, EPC and CRC-16, and the reader performs CRC. When no error is detected by the CRC, the reader successfully identifies information of the tag. Tags stay in Arbitrate state and Holding state until their slot counter values become 0. Tags in Arbitrate state do not participate in the current Inventory round until their slot counter values become 0. The tags reduce their slot counter values 1 by 1 every time the tags receive a QueryRep command from the reader. Although there are tags that have not yet been read, one round for identifying tags may be over. In this case, the reader broadcasts a QueryAdj command to the tags.

The RN16 code used according to the conventional EPCglobal Class1 Generation2 standard does not have any information on a product and unnecessarily wastes time. Consequently, a method for identifying a tag without using RN16 is required for fast tag identification.

### SUMMARY

The present invention is directed to providing radio frequency identification (RFID) tag identification methods for improving the performance of an anti-collision protocol through fast tag identification.

The present invention is also directed to providing an RFID reader for improving the performance of an anti-collision protocol through fast tag identification.

The present invention is also directed to providing an RFID tag for improving the performance of an anti-collision protocol through fast tag identification.

In example embodiments, a method of identifying a plurality of RFID tags in an RFID reader includes: generating a Query command to transmit the Query command to an RFID tag in a ready state; receiving an error detection code from the RFID tag that received the Query command; when the error detection code is received without a collision, generating an acknowledgement (ACK) command to transmit the acknowledgement (ACK) command to the RFID tag that transmitted the error detection code; and receiving tag information including a protocol control (PC) and an electronic product code (EPC) of the RFID tag that transmitted the error detection code.

The error detection code may be generated using the PC and the EPC of the RFID tag that transmitted the error detection code. The error detection code may be a cyclic redundancy check (CRC)-16 code. The method of identifying a plurality of RFID tags in an RFID reader may further include performing, at the RFID reader, a cyclic redundancy check (CRC) using the received CRC-16 code. The method of identifying a plurality of RFID tags in an RFID reader may further include determining, at the RFID reader, that a collision has occurred when the CRC-16 code is not correctly identified or when a reply to the ACK command is not received from the RFID tag. The tag information including the PC and the EPC may be transmitted to the RFID reader when the ACK command received by the RFID tag that transmitted the error detection code is valid. The tag information may not include the error detection code. The error detection code not included in the tag information may be a cyclic redundancy check (CRC)-16 code.

In other example embodiments, a method of identifying an RFID tag includes: receiving a Query command from an RFID reader; transmitting an error detection code to the RFID reader in response to the Query command; receiving an acknowledgement (ACK) command from the RFID reader that received the error detection code without a collision; and transmitting tag information including a protocol control (PC) and an electronic product code (EPC) of an RFID tag that transmitted the error detection code to the RFID reader. The error detection code may be generated using the PC and the EPC of the RFID tag that transmitted the error detection code. The error detection code may be a cyclic redundancy check (CRC)-16 code. The CRC-16 code may be used for the RFID reader to perform a cyclic redundancy check (CRC). The tag information including the PC and the EPC may be transmitted to the RFID reader when the ACK command received by the RFID tag that transmitted the error detection code is valid. The tag information may not include the error detection code, and the error detection code not included in the tag information may be a cyclic redundancy check (CRC)-16 code.

In still other example embodiments, a radio frequency identification (RFID) reader, includes: a transceiver configured to transmit and receive signals to and from a plurality of RFID tags; and a collision processor configured to generate a Query command to transmit the Query command to an RFID tag in a ready state via the transceiver, configured to generate an acknowledgement (ACK) command to transmit the acknowledgement (ACK) command to the RFID tag that transmitted an error detection code via the transceiver when the error detection code is received from the RFID tag that received the Query command via the transceiver without a collision, and configured to receive tag information including a protocol control (PC) and an electronic product code (EPC) of the RFID tag that transmitted the error detection code via the transceiver. The error detection code may be a cyclic redundancy check (CRC)-16 code generated using the PC and the EPC of the RFID tag that transmitted the error detection code, and the tag information may not include the CRC-16 code. The RFID reader may determine that a collision has occurred when the CRC-16 code is not correctly identified or when a reply to the ACK command is not received from the RFID tag that transmitted the error detection code. The tag information including the PC and the EPC may be transmitted to the RFID reader when the ACK command received by the RFID tag that transmitted the error detection code is valid.

In yet other example embodiments, a radio frequency identification (RFID) tag includes a memory storing unique information and an antenna for communication with an RFID reader, the RFID tag receiving a Query command from the RFID reader via the antenna, transmitting an error detection code to the RFID reader via the antenna in response to the Query command, receiving an acknowledgement (ACK) command via the antenna from the RFID reader that received the error detection code without a collision, and transmitting tag information including a protocol control (PC) and an electronic product code (EPC) to the RFID reader via the antenna. The error detection code may be a cyclic redundancy check (CRC)-16 code generated using the PC and the EPC of the RFID tag that transmitted the error detection code, and the tag information may not include the CRC-16 code.

### BRIEF DESCRIPTION OF THE DRAWINGS

The above and other objects, features and advantages of the present invention will become more apparent to those of ordinary skill in the art by describing in detail example embodiments thereof with reference to the attached drawings, in which:

FIG. 1 is a timing diagram illustrating a conventional method of identifying a tag using a dynamic framed-slotted ALOHA (DFSA) algorithm employing a random number with 16 bits (RN16) according to an electronic product code (EPC) global Class1 Generation2 standard;

FIG. 2 is a conceptual diagram illustrating operation of a reader and a tag according to the conventional EPCglobal Class1 Generation2 standard;

FIG. 3 is a block diagram of a radio frequency identification (RFID) system according to an example embodiment of the present invention;

FIG. 4 is a timing diagram illustrating a method of identifying a tag using cyclic redundancy check (CRC)-16 according to an example embodiment of the present invention;

FIG. 5 is a graph illustrating the uniformly random characteristic of CRC-16 used in a method of identifying a tag according to an example embodiment of the present invention;

FIG. 6 is a graph showing the number of bits used to identify one tag according to change in the number of tags when there are no channel errors; and

FIG. 7 is a graph showing the number of bits used to identify one tag according to change in the number of tags in an error-prone environment.

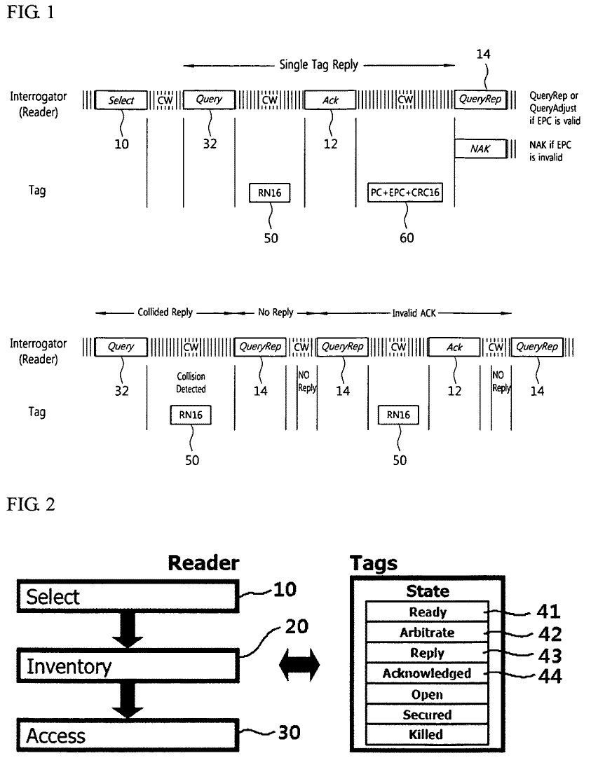

### DETAILED DESCRIPTION OF EXAMPLE EMBODIMENTS

Various example embodiments of the present invention will now be described more fully with reference to the accompanying drawings, in which some example embodiments of the invention are shown. However, specific structural and functional details disclosed herein are merely representative, for purposes of describing example embodiments of the present invention. This invention may be embodied in many alternate forms and should not be construed as limited to only the embodiments set forth herein. The scope of the invention is intended to cover all modifications, equivalents, and alternatives falling within the scope of the appended claims. Like numerals refer to like elements throughout the description and drawings.

A method of identifying a tag according to an example embodiment of the present invention uses a code, for example, a cyclic redundancy check (CRC)-16 code, functioning similar to a random number with 16 bits (RN16) code, instead of the RN16 code generated before tag information is transmitted according to a conventional Electronic product code (EPC) global Class1 Generation2 standard.

An RN16 generated from a random number generator (RNG) in a tag satisfies the following randomness conditions:

1. Probability of a Single RN16:

The probability P[RN16=j] of a single RN16 satisfies Equation 1 below:

0.8/2¹⁶<P[RN16=j]<1.25/2¹⁶ [Equation 1]

Here, j denotes a number generated by the RNG

2. Probability of Simultaneously Identical Sequences:

The probability that two or more tags among ten thousand tags simultaneously generate RN16s in the same sequence is 0.1% or less.

3. Probability of Predicting an RN16:

The probability of predicting an RN16 cannot be greater than 0.025%.

The tag identification method according to an example embodiment of the present invention uses a code, for example, the CRC-16 code, having characteristics similar to the RN16 code used according to the conventional EPCglobal Class1 Generation2 standard. As an example of the code having characteristics similar to the RN16, the CRC-16 code will be described below.

All burst errors having a length equal to or less than the degree of a polynomial can be detected by CRC. When a CRC-P mechanism is applied to random information of P bits, CRC values obtained from two different pieces of random information must be different. If the CRC values of two difference pieces of information are the same when one information bit sequence becomes the same as another information bit sequence due to a channel error, a burst error cannot be detected by CRC. This goes against the fact that all burst errors of a length equal to or less than the degree of P can be detected. Let us assume that two arbitrary pieces of information PC+EPC, for example, “1111000011110000” and “1100110011001100”, have the same CRC R generated by a CRC generator. When a sender transmits “1111000011110000” and R to a receiver, and the receiver receives the information “1100110011001100” altered by a channel error and R, the receiver cannot identify the error. Thus, each piece of information having P sequential bits must have only one CRC-P value.

In the EPCglobal Class1 Generation2 standard, a tag uses a CRC-16 to check the integrity of PC and EPC and transmits the CRC-16 to a reader.

All CRC-16s are uniquely different for every 16 sequential bits. This means that the probability of a CRC-16 is 1/2¹⁶, and CRC-16 has a uniformly random characteristic as RN16.

Thus, the probability P[CRC-16=j] of a single CRC-16 satisfies Equation 2 below:

0.8/2¹⁶<P[CRC-16=j]<1.25/2¹⁶ [Equation 2]

Here, j denotes a number corresponding to CRC-16.

The number of tags whose 16 bits of CRC-16 are the same can be obtained by multiplying the probability of a single CRC-16 by ten thousand, and is less than 0.1% of ten thousand tags. Thus, CRC-16 meets the second condition of RN16.

When a reader identifies tags, the tags are randomly selected, and the probability of predicting a CRC-16 is 1/2¹⁶. In other words, the probability of predicting a CRC-16 is not greater than 0.025%.

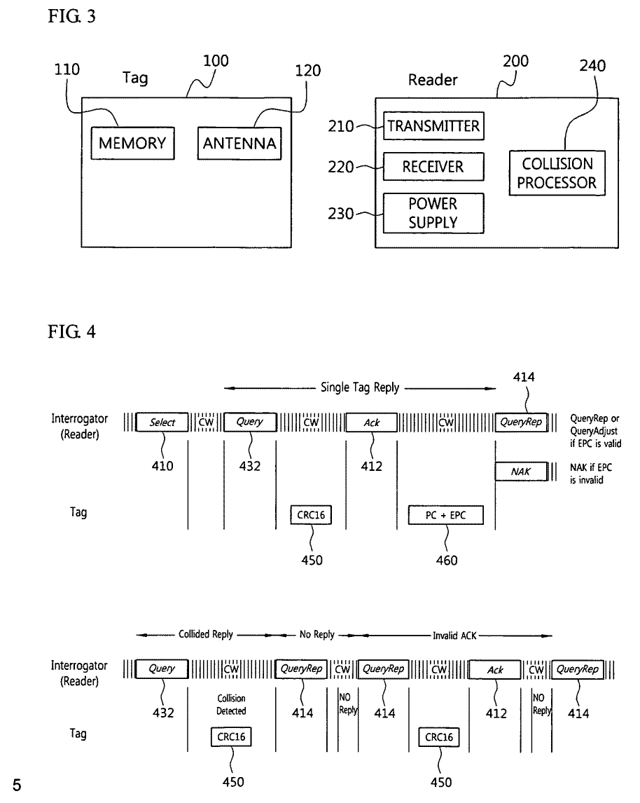

FIG. 3 is a block diagram of a radio frequency identification (RFID) system according to an example embodiment of the present invention.

Referring to FIG. 3, the RFID system includes a tag 100 and a reader 200.

The tag 100 has a memory 110 storing unique information, and an antenna 120 for communication with the reader 200. The memory 110 may be a non-volatile memory such as a read-only memory (ROM), or a volatile memory such as a random access memory (RAM).

When the tag 100 comes close to the reader 200 and is activated, the tag transmits the tag's information to the reader 200 through the antenna 120, and the reader 200 can obtain the tag information. The tag 100 may be activated when the tag comes close to the reader 200 and is supplied with electric power from a power supply 230 of the reader 200. Alternatively, the tag 100 may activate by itself without receiving electric power from the reader 200 when a power supply (not shown in FIG. 3) is included in the tag 100.

The reader 200 may include a transceiver, a power supply 230 and a collision processor 240. The transceiver may include a transmitter 210 and a receiver 220.

The reader 200 transmits and receives signals, such as a command and data, through the transmitter 210 and the receiver 220.

The collision processor 240 controls a collision processing procedure employing CRC-16 according to an example embodiment of the present invention. The collision processor 240 generates a Query command and transmits the Query command to an RFID tag in Ready state through the transceiver. When the collision processor 240 receives an error detection code from the RFID tag that received the Query command through the transceiver without a collision, the collision processor 240 generates an acknowledgement (ACK) command and transmits the ACK command to the RFID tag that transmitted the error detection code through the transceiver. The collision processor 240 receives tag information including the protocol control (PC) and the EPC of the RFID tag that transmitted the error detection code through the transceiver.

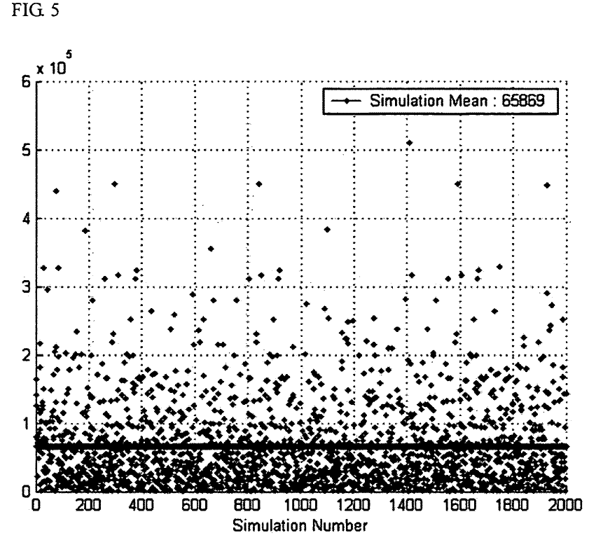

FIG. 4 is a timing diagram illustrating a method of identifying a tag using CRC-16 according to an example embodiment of the present invention.

Referring to FIG. 4, when long PC, EPC, and CRC-16 are transmitted without transmitting a short RN16 in advance, a tag collision wastes time and reduces tag identification speed because another PC, EPC and CRC-16 need to be transmitted. Thus, according to the conventional EPCglobal Class1 Generation2 standard, RN16 is used when a tag transmits information to a reader.

The tag identification method according to an example embodiment of the present invention performs tag identification using an error detection code, for example, CRC-16, instead of RN16. Here, error detection codes other than the CRC-16 code can also be used as long as the error detection codes other than the CRC-16 code have the characteristics of RN16 used according to the conventional EPCglobal Class1 Generation2 standard. The case of using CRC-16 as an example of the error detection code will be described below.

In the tag identification method according to an example embodiment of the present invention, slot counter values of tags are determined by a Query command 432, a QueryRep command 414, or a QueryAdjust command.

A reader 200 generates a Select command 410 and selects a particular timeslot in which the reader identifies one tag. To identify the tag, the reader 200 transmits Query, ACK, NAK, etc., commands to tags in Inventory round. In Access state, the reader 200 reads or writes data from or to individual tags after the tags are uniquely identified.

The tag that received the Select command 410 prepares for operation and stays in Ready state until the tag receives the Query command 432. Each tag randomly selects a timeslot. The tag that received the Query command 432 backscatters a 16-bit CRC-16 450 to the reader 200 in the selected timeslot when its slot counter value is reduced to 0. Here, the CRC-16 450 is generated using tag information 460 including the PC and the EPC.

When the reader 200 does not detect a collision of CRC-16 and correctly and successfully receives the CRC-16 450, the reader generates an ACK command 412 and transmits the generated ACK command 412 to the tag, thereby requesting the tag information 460 including the PC and the EPC.

After receiving the ACK command 412, the tag switches to Acknowledged state. When the received ACK command 412 is valid, the tag transmits the tag information 460 including its PC and EPC to the reader 200.

The reader 200 that received the tag information 460 including the PC and the EPC performs CRC using the already received CRC-16 450. When no error is detected by the CRC, the reader 200 successfully identifies the tag information 460.

When there is no reply during a specific time, the reader 200 tries to read the tag at the next smallest slot counter value.

However, when the CRC-16 450 is not correctly identified, or there is no reply to the ACK command 412, the reader 200 determines that a collision has occurred.

Tags reduce their slot counter values by 1 every time the tags receive the QueryRep command 414 from the reader 200. When one round for identifying tags is over but there are tags that have not yet been read, the reader 200 broadcasts the QueryAdjust command to the tags.

The tag identification method using CRC-16 according to an example embodiment of the present invention will be compared below with a conventional tag identification method using RN16 according to the EPCglobal Class1 Generation2 standard.

The lengths of tag IDs and commands of a reader may be set in Table 1 below.

TABLE 1

| Command | No. of bits | Command | No. of bits |
|---|---|---|---|
| RN16 | 16 bits | Select | 44 bits |
| PC | 16 bits | QueryAdj | 9 bits |
| EPC | 64 bits | QueryRep | 4 bits |
| Query | 22 bits | ACK | 18 bits |
| NAK | 8 bits | RN16 | 16 bits |

According to the conventional EPCglobal Class1 Generation2 standard, a Q selection algorithm in which tags select Q values from a Query command is used to prevent a tag collision.

The Q selection algorithm based on a framed-slotted ALOHA (FSA) scheme adjusts the number of timeslots in a next round according to the number of collisions and the number of idle timeslots, and tags again select different random count values from a reader generating a Query or QueryAdjust command.

However, the Q selection algorithm is not specified in the EPCglobal Class1 Generation2 standard. Thus, assuming that the reader knows the accurate number of tags, example embodiments of the present invention employ the dynamic FSA (DFSA) algorithm instead of the Q selection algorithm to solve the problem of tag collision.

FIG. 5 is a graph illustrating uniformly random characteristics of CRC-16 used in a method of identifying a tag according to an example embodiment of the present invention.

When a CRC-16 is given, the x-axis denotes simulation number and the y-axis represents how many repetitions are needed until the CRC-16 of PC and EPC of a randomly selected tag and the given CRC-16 become the same value. When CRC-16 is uniformly random, the same CRC-16 may be repeated every 2¹⁶ (65536) times on average. The expected mean, 65536, is very close to a simulation mean, 65869, within a range of about 0.5%. Thus, the uniformly random characteristic of CRC-16 can be verified.

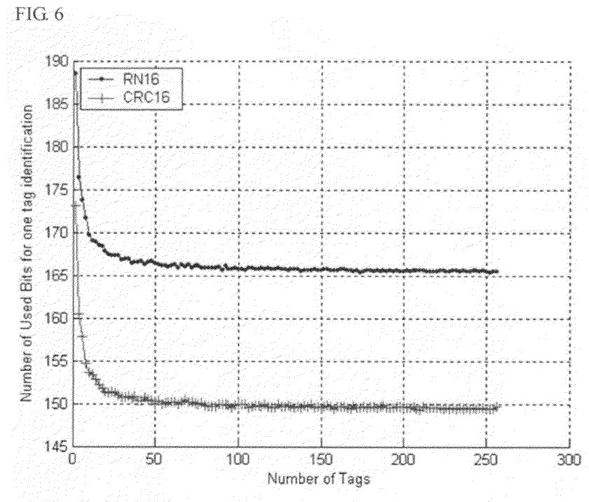

FIG. 6 is a graph showing the number of bits used to identify one tag according to change in the number of tags when there are no channel errors. When the number of tags is 256, the tag identification method according to an example embodiment of the present invention uses 149.7 bits to identify one tag while the conventional tag identification method employing RN16 according to the EPCglobal Class1 Generation2 standard uses 165.48 bits. Since the tag identification method according to an example embodiment of the present invention does not use the 16 bits of RN16, the difference between the number of bits required for the tag identification method according to an example embodiment of the present invention and that required for the conventional tag identification method employing RN16 is about 16 bits. Thus, the performance of the tag identification method according to an example embodiment of the present invention is improved by about 9.53%.

In RFID systems, tags perform backscattering at low power, and thus many channel errors occur.

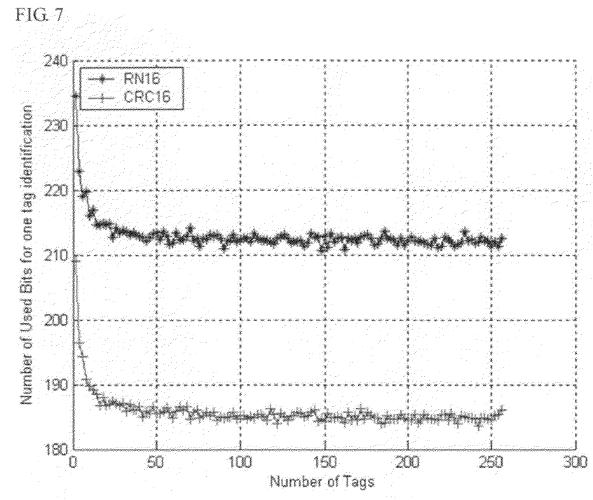

FIG. 7 illustrates how much improvement is achieved by the tag identification method according to an example embodiment of the present invention in an error-prone environment.

FIG. 7 is a graph showing the number of bits used to identify one tag according to change in the number of tags in an error-prone environment.

In a channel error environment, when the packet error rate (PER) is 0.3 and the number of tags is 256, the tag identification method according to an example embodiment of the present invention uses 186.09 bits to identify one tag while the conventional tag identification method employing RN16 according to the EPCglobal Class1 Generation2 standard uses 212.62 bits. This result shows that the tag identification method according to an example embodiment of the present invention takes less time than the conventional tag identification method employing RN16 and saves the 16 bits of RN16 as when there are no channel errors. Thus, the performance of the tag identification method according to an example embodiment of the present invention is improved by about 12.5%.

According to the above-described example embodiment of the present invention, a simple and efficient tag identification method is provided, which uses an error detection code, such as CRC-16, having a uniformly random characteristic as RN16 instead of RN16 used according to the conventional EPCglobal Class1 Generation2 standard.

Therefore, the tag identification method using an error detection code such as CRC-16 according to example embodiments of the present invention takes less time than a conventional tag identification method using RN16 according to the EPCglobal Class1 Generation2 standard, regardless of channel errors.

While the invention has been shown and described with reference to certain example embodiments thereof, it will be understood by those skilled in the art that various changes in form and details may be made therein without departing from the spirit and scope of the invention as defined by the appended claims.

What is claimed is:

1. A method of identifying a plurality of radio frequency identification (RFID) tags in an RFID reader, comprising:
generating a Query command to transmit the Query command to an RFID tag in a ready state;
receiving an error detection code from the RFID tag that received the Query command;
when the error detection code is received without a collision, generating an acknowledgement (ACK) command to transmit the acknowledgement (ACK) command to the RFID tag that transmitted the error detection code; and
receiving tag information including a protocol control (PC) and an electronic product code (EPC) of the RFID tag that transmitted the error detection code.

2. The method of claim 1, wherein the error detection code is generated using the PC and the EPC of the RFID tag that transmitted the error detection code.

3. The method of claim 2, wherein the error detection code is a cyclic redundancy check (CRC)-16 code.

4. The method of claim 3, further comprising performing, at the RFID reader, a cyclic redundancy check (CRC) using the received CRC-16 code.

5. The method of claim 3, further comprising determining, at the RFID reader, that a collision has occurred when the CRC-16 code is not correctly identified or when a reply to the ACK command is not received from the RFID tag.

6. The method of claim 1, wherein the tag information including the PC and the EPC is transmitted to the RFID reader when the ACK command received by the RFID tag that transmitted the error detection code is valid.

7. The method of claim 1, wherein the tag information does not include the error detection code.

8. The method of claim 7, wherein the error detection code not included in the tag information is a cyclic redundancy check (CRC)-16 code.

9. A method of identifying a radio frequency identification (RFID) tag, comprising:
receiving a Query command from an RFID reader;
transmitting an error detection code to the RFID reader in response to the Query command;
receiving an acknowledgement (ACK) command from the RFID reader that received the error detection code without a collision; and
transmitting tag information including a protocol control (PC) and an electronic product code (EPC) of an RFID tag that transmitted the error detection code to the RFID reader.

10. The method of claim 9, wherein the error detection code is generated using the PC and the EPC of the RFID tag that transmitted the error detection code.

11. The method of claim 10, wherein the error detection code is a cyclic redundancy check (CRC)-16 code.

12. The method of claim 11, wherein the CRC-16 code is used for the RFID reader to perform a cyclic redundancy check (CRC).

13. The method of claim 9, wherein the tag information including the PC and the EPC is transmitted to the RFID reader when the ACK command received by the RFID tag that transmitted the error detection code is valid.

14. The method of claim 9, wherein the tag information does not include the error detection code, and the error detection code not included in the tag information is a cyclic redundancy check (CRC)-16 code.

15. A radio frequency identification (RFID) reader, comprising:
a transceiver configured to transmit and receive signals to and from a plurality of RFID tags; and
a collision processor configured to generate a Query command to transmit the Query command to an RFID tag in a ready state via the transceiver, configured to generate an acknowledgement (ACK) command to transmit the acknowledgement (ACK) command to the RFID tag that transmitted an error detection code via the transceiver when the error detection code is received from the RFID tag that received the Query command via the transceiver without a collision, and configured to receive tag information including a protocol control (PC) and an electronic product code (EPC) of the RFID tag that transmitted the error detection code via the transceiver.

16. The RFID reader of claim 15, wherein the error detection code is a cyclic redundancy check (CRC)-16 code generated using the PC and the EPC of the RFID tag that transmitted the error detection code, and the tag information does not include the CRC-16 code.

17. The RFID reader of claim 16, wherein the RFID reader determines that a collision has occurred when the CRC-16 code is not correctly identified or when a reply to the ACK command is not received from the RFID tag that transmitted the error detection code.

18. The RFID reader of claim 15, wherein the tag information including the PC and the EPC is transmitted to the RFID reader when the ACK command received by the RFID tag that transmitted the error detection code is valid.

19. A radio frequency identification (RFID) tag including a memory storing unique information and an antenna for communication with an RFID reader, the RFID tag receiving a Query command from the RFID reader via the antenna, transmitting an error detection code to the RFID reader via the antenna in response to the Query command, receiving an acknowledgement (ACK) command via the antenna from the RFID reader that received the error detection code without a collision, and transmitting tag information including a protocol control (PC) and an electronic product code (EPC) to the RFID reader via the antenna.

20. The RFID tag of claim 19, wherein the error detection code is a cyclic redundancy check (CRC)-16 code generated using the PC and the EPC of the RFID tag that transmitted the error detection code, and the tag information does not include the CRC-16 code.
